(19) United States
(12) Patent Application Publication
(10) Pub. No.: US 2018/0207924 A1
(43) Pub. Date: Jul. 26, 2018

(54) METHOD AND SYSTEM FOR ADDITIVE MANUFACTURING OF COMPLEX METAL PART BY SHEET LAMINATION

(71) Applicant: Beijing HK-Precisions Co., Ltd, Beijing (CN)

(72) Inventor: Linbo Wu, Beijing (CN)

(21) Appl. No.: 15/934,537

(22) Filed: Mar. 23, 2018

Related U.S. Application Data
(63) Continuation of application No. PCT/CN2016/108678, filed on Dec. 6, 2016.

(30) Foreign Application Priority Data
Dec. 30, 2015 (CN) 201511003859.9

(51) Int. Cl. B32B 38/00; B32B 37/06; B32B 38/16; B32B 1/00; B32B 15/01; B23P 17/00

(52) U.S. Cl. CPC B32B 38/0012; B32B 38/0008; B32B 37/06; B33Y 10/00; B32B 1/00; B32B 15/01; B23P 17/00; B32B 38/162

(57) ABSTRACT

The present invention discloses a method and a system for additive manufacturing of a complex metal part by sheet lamination, and belongs to the field of manufacturing. A three-dimensional data model of a part is sliced into metal sheets, the metal sheets are molded, and each metal sheet is combined into the part by using diffusion welding or friction welding. A diffusion welding or friction welding technique is introduced in additive manufacturing, so that a production capacity of additive manufacturing is further expanded and supplemented, so as to manufacture parts with higher precision and better finish quality.

This application is a continuation-in-part of International Application No. PCT/CN2016/108678, filed on Dec. 6, 2016, which is based upon and claims priority to Chinese Patent Application No. 201511003859.9, filed on Dec. 30, 2015, the entire contents of which are incorporated herein by reference.

### BACKGROUND

### Technical Field

The present invention relates to the field of additive manufacturing, and more particularly to a method and a system for additive manufacturing of a complex metal part by sheet lamination.

### Related Art

Additive manufacturing techniques develop rapidly in recent years. However, so far, in additive manufacturing of metal parts, basically, metal powder is molded by using high-temperature sintering deposition using laser or plasma. After solidification, pores exist between powder particles of a metal material, and as a result, a beehive-form structure is easily formed in sintering of metal powder. Therefore, due to factors such as a high cost, low efficiency, and poor mechanical performance of metal powder, metal powder can hardly be widely applied.

A current additive manufacturing process is usually suitable for manufacturing of only a sample and a part that cannot be completed by using a conventional processing method. Moreover, only blanks of parts can be produced. In this case, precision and finish quality cannot be ensured, and requirements in an assembly process of the parts are not met. A conventional mechanical processing manner further requires to be used to process assembly surfaces of the parts to meet precision requirements of the parts. In a case of a part that has a relatively complex internal structure, some areas are unreachable by using a milling cutter or another cutter, and therefore a requirement of high finish quality cannot be achieved.

### SUMMARY

Embodiments of the present invention provide a method and a system for additive manufacturing of a complex metal part by sheet lamination.

According to a first aspect of embodiments of the present invention, a method for additive manufacturing of a complex metal part by sheet lamination is provided, where the method includes:

slicing a three-dimensional data model of a part into layers;

molding each layer to form a metal sheet; and

combining each metal sheet into the part by using diffusion welding or friction welding.

Optionally, the method further includes:

before the combining each metal sheet into the part by using diffusion welding or friction welding, performing fine grinding and cleaning on each metal sheet.

Optionally, the method further includes:

before the performing fine grinding and cleaning on each metal sheet, processing each metal sheet by using an electric spark.

Optionally, the performing fine grinding and cleaning on each metal sheet includes:

performing fine grinding on each metal sheet according to a set parameter; and

cleaning each metal sheet after fine grinding, where

the set parameter includes: a thickness of performing fine grinding on a surface of each metal sheet.

Optionally, the combining each metal sheet into the part by using diffusion welding includes:

laminating each metal sheet after fine grinding and cleaning;

increasing a temperature to a first set value, and increasing a pressure to a second set value; and

when the first set value and the second set value are kept for over a first set time, reducing the temperature, and reducing the pressure, where

the first set value is related to the material of each metal sheet, the second set value is related to a cross-sectional area of each metal sheet, and the first set time is related to a thickness of each metal sheet and a thickness of a welding layer.

Optionally, the combining each metal sheet into the part by using friction welding includes:

laminating each metal sheet after fine grinding and cleaning;

increasing a temperature of the metal sheets to a third set value by producing friction between each metal sheet through driving;

stopping the friction, and increasing a pressure to a fourth set value; and

keeping the fourth set value over a second set time, where

the third set value is related to the material of each metal sheet, the fourth set value is related to a cross-sectional area of each metal sheet, and the second set time is related to a thickness of a welding layer.

Optionally, the molding each layer to form a metal sheet includes:

manufacturing each metal sheet through mechanical processing by using data of the layers, where the mechanical processing includes: laser cutting, plasma cutting, and processing using a machining center.

Optionally, the method further includes:

obtaining measurement data of a form, a position, and a size of the part; and

comparing the measurement data with standard data, and calculating a form-and-position tolerance and a size tolerance.

Optionally, each metal sheet is made of a same material or different materials.

According to a second aspect of embodiments of the present invention, a system for additive manufacturing of a complex metal part by sheet lamination is provided, where the system includes:

a layer-slicing apparatus, configured to slice a three-dimensional data model of a part into layers; a molding apparatus, configured to mold each layer to form a metal sheet; and a welding apparatus, configured to combine each metal sheet into the part by using diffusion welding or friction welding. Further optionally, the system further includes: an automated guided vehicle (AGV), configured to convey each metal sheet formed by using the molding apparatus.

Optionally, the system further includes:

a fine grinding and cleaning apparatus, configured to: before the welding apparatus performs an operation, perform fine grinding and cleaning on each metal sheet. Further optionally, the system further includes: an AGV, configured to convey each metal sheet after the fine grinding and cleaning apparatus performs fine grinding and cleaning.

Optionally, the system further includes:

an electric spark processing apparatus, configured to: before the fine grinding and cleaning apparatus performs an operation, process each metal sheet by using an electric spark. Further optionally, the system further includes: an AGV, configured to convey each metal sheet after processing by the electric spark processing apparatus.

The technical solutions provided in the embodiments of the present invention may include the following beneficial effects.

In the method and system for additive manufacturing of a complex metal part by sheet lamination provided in the embodiments of the present invention, a three-dimensional data model of a part is first sliced into layers, each layer is then molded to form a metal sheet, and each metal sheet is eventually combined into the part by using diffusion welding or friction welding. In an aspect, a three-dimensional model of a part is sliced into layers, and each layer is molded to form a metal sheet. In this process, manufacturing may be completed layer by layer according to sizes and precision in a manufacturing process, so that precision and finish quality of each metal sheet is ensured. In another aspect, diffusion welding and friction welding are both bonding techniques on an atomic level, so that bonding of each metal sheet that meets requirements of precision and finish quality can be ensured. Based on the foregoing two aspects, requirements of precision and finish quality of an entire part can be met.

It should be understood that, the foregoing general description and the following detailed description are merely exemplary and explanatory, and cannot be used to limit the present invention.

### BRIEF DESCRIPTION OF THE DRAWINGS

The accompanying drawings herein, which are incorporated into and constitute a part of the specification, illustrate embodiments consistent with the present invention, and together with the specification, serve to explain the principle of the present invention.

FIG. 1 is a schematic flowchart of a method for additive manufacturing of a complex metal part by sheet lamination according to an exemplary embodiment;

FIG. 2 is a schematic flowchart of a method for additive manufacturing of a complex metal part by sheet lamination according to an exemplary embodiment;

FIG. 3 is a three-dimensional axonometric chart of a part according to an exemplary embodiment;

FIG. 4 is a top view of the part shown in FIG. 3;

FIG. 5 is a sectional view of the part shown in FIG. 3;

FIG. 6 is a front view of layers of the part shown in FIG. 3;

FIG. 7 is an axial view of the layers of the part shown in FIG. 3;

FIG. 8 is a sectional view of a sequenced combination of the part shown in FIG. 3;

FIG. 9 is a block diagram of a system for additive manufacturing of a complex metal part by sheet lamination according to an exemplary embodiment; and

FIG. 10 is a block diagram of a system for additive manufacturing of a complex metal part by sheet lamination according to an exemplary embodiment.

### DETAILED DESCRIPTION

The following description and accompanying drawings thoroughly show specific implementation solutions of the present invention, so that a person skilled in the art can implement the specific implementation solutions. Embodiments represent only possible changes. Unless clearly required, separate members and functions are optional, and an order of operations may change. Parts and features of some implementation solutions may be included in or may be used to replace parts and features in another implementation solution. The scope of the implementation solutions of the present invention includes the entire scope of the claims and all attainable equivalents of the claims. In the specification, the implementation solutions may be separately or generally represented by using the term “invention” for convenience only. Moreover, if more than one invention is actually disclosed, it is not to automatically limit the scope of the application to any single invention or inventive concept. In the specification, relationship terms such as first and second are merely used to distinguish one entity or operation from another entity or operation, rather than to require or imply that any actual relationship or order exists between these entities or operations. Moreover, the term “include”, “contain” or any another variant thereof intends to cover non-exclusive containment, so that a process, method or device that includes a series of elements not only include those elements, but also includes another element that is not clearly listed. The embodiments in the specification are described in a progressive manner, and each embodiment focuses on a difference from other embodiments, and for same or similar parts in the embodiments, reference may be made between the embodiments. A structure, a product or the like that is disclosed in the embodiments corresponds to a part disclosed in the embodiments, and is therefore described in a relatively simple manner. For related points, reference may be made to the description of the method part.

In an exemplary embodiment, a complex metal part is sliced into layers in a direction, to obtain several sheets that may be implemented by using a conventional processing process and have a certain thickness. A process such as laser cutting, plasma cutting, and mechanical processing using a machining center is performed on these sheets, to obtain each metal sheet-shaped part that has high precision and desirable finish quality. A manner such as diffusion welding, friction welding or plasma welding is then used for processed sheet-shaped parts to implement sheet bonding of the metal part, and eventually the complete metal part is molded.

In this embodiment, the metal part is automatically divided by using software and using a proper algorithm into several sheets that can be processed by using a conventional process.

In this embodiment, the foregoing sheets may be obtained by using a conventional processing process. These measures include a process such as laser cutting, plasma cutting, and mechanical processing using a machining center, and a combination of these processing processes.

In this embodiment, sheet bonding of the metal part is implemented by using a manner such as diffusion welding, friction welding or plasma welding.

In this embodiment, the complex metal part is molded and manufactured by using metal sheet lamination.

In this embodiment, physical performance, surface finish quality, and size precision of the molded metal part all meet requirements of conventional processing processes.

In this embodiment, metal sheets and some kind of non-metal sheets can also be bonded into one part by using such a process.

In this embodiment, metal sheets that are made of different alloy materials can also be bonded into one part by using such a process.

In this embodiment, an entire process of additive manufacturing is automatically implemented by using an additive manufacturing system that is formed of several devices.

To express the main content of the solution in this embodiment with method steps, the method steps may include the following four steps.

In step 1: Establish a three-dimensional structural graphic of a target part.

In step 2: Choose a suitable position to perform layer-by-layer slicing in a specific direction of the three-dimensional structural graphic, to obtain a graphic of multiple layered-structure parts that are easy to process and have a particular thickness.

In step 3: Manufacture, by combining processes of various mechanical processing manners such as laser cutting, water-jet cutting, and processing using a machining center, the layered-structure parts that have high precision and desirable finish quality.

In step 4: Laminate the layered parts in sequence, and obtain the target part by using diffusion welding or friction welding.

By means of the method in this embodiment, issues of precision and finish quality can be resolved, so that a part reaches mechanical performance of a precision forging part, and at the same time a manufacture cost is reduced and production efficiency is achieved.

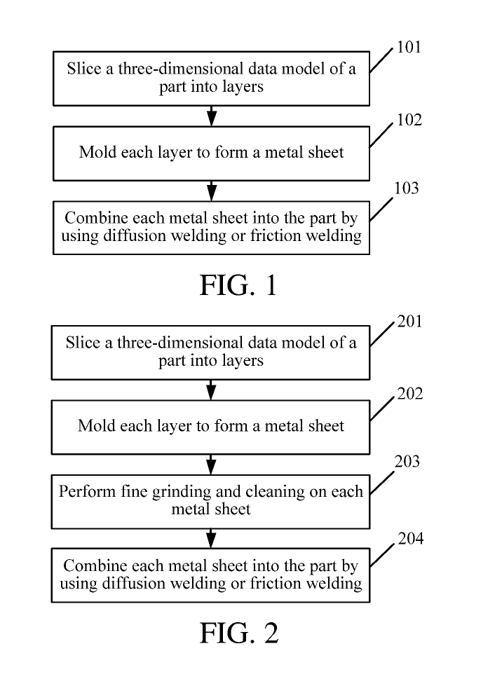

FIG. 1 is a schematic flowchart of a method for additive manufacturing of a complex metal part by sheet lamination according to an exemplary embodiment. The method includes the following steps.

In step 101: Slice a three-dimensional data model of a part into layers.

In step 102: Mold each layer to form a metal sheet.

In step 103: Combine each metal sheet into the part by using diffusion welding or friction welding.

As can be seen, in the method for additive manufacturing of a complex metal part by sheet lamination provided in this embodiment of the present invention, a three-dimensional data model of a part is first sliced into layers, each layer is then molded to form a metal sheet, and each metal sheet is eventually combined into the part by using diffusion welding or friction welding. In an aspect, a three-dimensional model of a part is sliced into layers, and each layer is molded to form a metal sheet. In this process, manufacturing may be completed layer by layer according to sizes and precision in a manufacturing process, so that precision and finish quality of each metal sheet is ensured. In another aspect, diffusion welding and friction welding are both bonding techniques on an atomic level, so that bonding of each metal sheet that meets requirements of precision and finish quality can be ensured. Based on the foregoing two aspects, requirements of precision and finish quality of an entire part can be met.

FIG. 2 is a schematic flowchart of a method for additive manufacturing of a complex metal part by sheet lamination according to an exemplary embodiment. The method includes the following steps.

In step 201: Slice a three-dimensional data model of a part into layers.

As an optional implementation manner, a three-dimensional data model of a part may be first designed by using a reverse design method. The three-dimensional data model is then sliced into layers according to the complexity of the structure of the part and a material and a size of the part. For example, when the structure of the part is more complex, a quantity of layers is larger; when the material of the part is softer, the quantity of layers is smaller; and when the size of the part is smaller, the size of the layers is smaller.

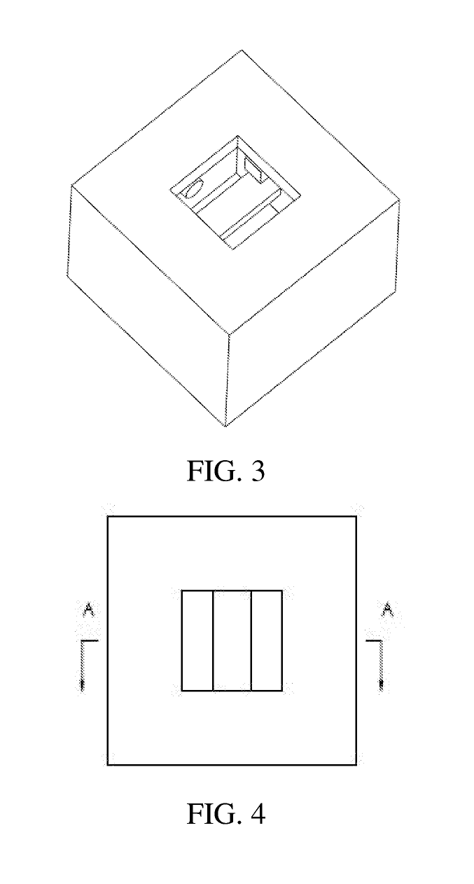

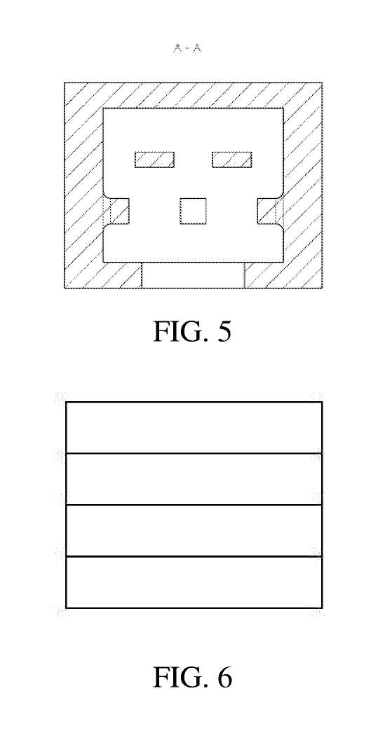

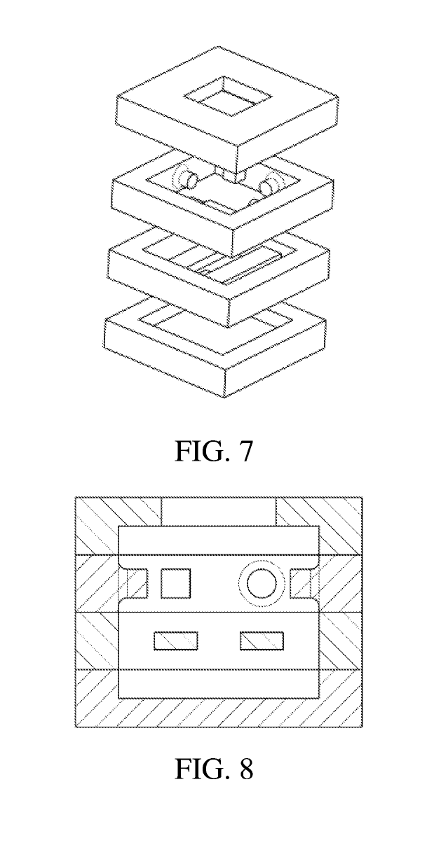

FIG. 3 is a three-dimensional axonometric chart of a part according to an exemplary embodiment. FIG. 4 is a top view of the part shown in FIG. 3. FIG. 5 is a sectional view of the part shown in FIG. 3. FIG. 6 is a front view of layers of the part shown in FIG. 3. FIG. 7 is an axial view of the layers of the part shown in FIG. 3. FIG. 8 is a sectional view of a sequenced combination of the part shown in FIG. 3.

In step 202: Mold each layer to form a metal sheet.

As an optional implementation manner, a metal sheet may be manufactured through mechanical processing by using data of layers that is obtained after the three-dimensional data model is sliced into the layers. The mechanical processing may include: laser cutting, plasma cutting, and processing using a machining center.

The formed metal sheets are physical members having a structure same as that in FIG. 7.

In step 203: Perform fine grinding and cleaning on each metal sheet.

In a molding process, oxide layers and purities are formed on surface of each metal sheet. The oxide layers and purities may be removed by using fine grinding and cleaning, to prepare for subsequent diffusion welding or friction welding.

As an optional implementation manner, fine grinding is performed according to a set parameter. An effect of cleaning is to remove oil stains and purities that are generated after fine grinding. The foregoing set parameter refers to a thickness of performing fine grinding on a surface of a metal sheet.

In diffusion welding or friction welding, to reach relatively desirable bonding efficiency and precision, after each metal sheet is laminated, there is a requirement on a gap between every two metal sheets, and the gap is usually required to be less than or equal to 10 micrometers. Because molded metal sheets have oxide layers, after each metal sheet is laminated, the gap between every two metal sheets is greater than this value. It is assumed that the gap is 30 micrometers. In this case, the thickness of fine grinding is 20 micrometers.

In Step 204: Combine each metal sheet into the part by using diffusion welding or friction welding.

As an optional implementation manner, the combining each metal sheet into the part by using diffusion welding may include the following sub-steps.

In sub-step 1: Laminate each metal sheet after fine grinding and cleaning.

Lamination refers to align and bond every two metal sheets in a position according to a design requirement.

In sub-step 2: Increase a temperature to a first set value, and increase a pressure to a second set value.

In sub-step 3: When the first set value and the second set value are kept for over a first set time, reduce the temperature, and reduce the pressure.

It may be seen that in diffusion welding, by means of a set temperature and a set pressure, two laminated metal sheets first exert effects on each other, so as to form bonding between atoms. Within a time when the temperature is kept, the atoms then diffuse to each other, to form a secure bonding layer. After diffusion welding, a boundary between every two metal sheets disappears completely and micro pores are eliminated completely, so that secure connection is achieved at the joint, and crystallized material becomes homogeneous. Therefore, the temperature, the pressure, and the time are parameters in a process of diffusion welding. In a case in which bonding efficiency and precision are considered, when the temperature, the pressure, and the time are set to suitable values, there is a requirement on a distance after each metal sheet is laminated. According to the foregoing description, each metal sheet after fine grinding and cleaning can meet the foregoing requirement of distances. Therefore, it is equivalent that fine grinding and cleaning ensure that parameters of diffusion welding are kept at desirable levels, thereby ensuring bonding efficiency and precision.

To ensure that the metal sheets can be securely bonded with each other, and overall shapes and sizes of the parts meet design requirements, values of the temperature, the pressure, and the time are controlled.

In some embodiments, the first set value is related to the material of each metal sheet, the second set value is related to a cross-sectional area of each metal sheet, and the first set time is related to a thickness of each metal sheet and a thickness of a welding layer.

In some embodiments, correspondences between the materials of some metal sheets and the values of the temperature, the pressure, and the time are as shown in Table 1:

TABLE 1

| Alloy | Thickness mm | Temperature ° C. | Pressure Mpa | Time h |
|---|---|---|---|---|
| Copper alloy | 5 | 500 | 20 | 3 |
| Iron alloy | 5 | 850 | 15 | 6 |
| Aluminum alloy | 5 | 350 | 12 | 3 |
| Aluminum alloy | 10 | 350 | 12 | 3.5 |

It may be understood that, Table 1 only shows exemplary data, and the metal sheet may further be of other materials. Examples are not exhaustively listed herein.

In some embodiments, a higher melting point of a metal material indicates a higher corresponding temperature, that is, a larger first set value.

For the metal sheets of different cross-sectional areas, the values of the pressure are also different, that is, the second set values are different.

Optionally, a larger cross-sectional area of the metal sheet indicates a larger second set value. In some embodiments, the second set value may be determined according to a formula (1):

F=aS formula (1), where

in the formula (1), F is a set value of the pressure, S is the cross-sectional area of the metal sheet, and a is a set pressure intensity coefficient.

In some embodiments, the set coefficient a depends on a deformation amount £ and an elastic modulus E of the metal material. For the metal sheets of different thicknesses, the time is different, that is, the first set time is different.

Optionally, a larger thickness of the metal sheet and a larger thickness of the welding layer indicate a longer first set time. In some embodiments, the first set time may be determined according to a formula (2-1) as below:

t=bX²+md² formula (2-1), where

in the formula (2-1), t is the first set time, X is the thickness of the metal sheet, b is a set weighting coefficient, m is a set weighting coefficient, d is the thickness of the welding layer.

In some embodiments, the first set time may be determined according to a formula (2-2) as below:

t=bX+md formula (2-2), where

in the formula (2-2), t is the first set time, X is the thickness of the metal sheet, b is a set weighting coefficient, m is a set weighting coefficient, d is the thickness of the welding layer.

In some embodiments, the first set time may be determined according to a formula (2-3) as below:

t=bX*d formula (2-3), where

in the formula (2-3), t is the first set time, X is the thickness of the metal sheet, b is a set weighting coefficient, d is the thickness of the welding layer.

In some embodiments, a value of the weighting coefficient b depends on a density, a thermal transmission coefficient, a specific heat, and a working temperature of the metal material.

In some embodiments, a value of the weighting coefficient m depends on a diffusion constant, an activation energy of diffusion, and a metallographic state after atomic diffusion.

In some embodiments, b=ρcλ⁻¹(ln T+K₁), where ρ is the density of the metal material, c is the specific heat, λ is the thermal transmission coefficient, T is the working temperature, and K1 is a device constant.

The second set value is determined based on the formula (1), and the first set time is determined based on the formula (2-1), the formula (2-2), or the formula (2-3), so that the metal sheets can be securely bonded with each other, and the overall shapes and sizes of the parts meet design requirements, thereby ensuring bonding efficiency and precision.

As an optional implementation manner, the combining each metal sheet into the part by using friction welding may include the following sub-steps.

In sub-step 1′: Laminate each metal sheet after fine grinding and cleaning.

In sub-step 2′: Increase a temperature between each metal sheet to a third set value by producing friction between each metal sheet through driving.

In sub-step 3′: Stop friction, and increase a pressure to a fourth set value.

In sub-step 4′: Keep the fourth set value over a second set time.

It may be seen that, in friction welding, heat is first generated through friction between two laminated metal sheets. When the temperature reaches a particular value, stop friction and increase a pressure. When the pressure is kept for over a particular time, a force of attraction between atoms is used to form a secure bonding layer. After friction welding, an effect similar to that of diffusion welding can be achieved. Therefore, the temperature, the pressure, and the time are also important parameters in a process of friction welding. In a case in which bonding efficiency and precision are considered, when the temperature, the pressure, and the time are set to suitable values, there is a requirement on a distance after each metal sheet is laminated. According to the foregoing description, each metal sheet after fine grinding and cleaning can meet the foregoing requirement of distances. Therefore, it is equivalent that fine grinding and cleaning ensure that parameters of diffusion welding are kept at desirable levels, thereby ensuring bonding efficiency and precision.

In some embodiments, the third set value is related to the material of each metal sheet, the fourth set value is related to a cross-sectional area of each metal sheet, and the second set time is related to a thickness of a welding layer

In some embodiments, a higher melting point of a metal material indicates a higher corresponding temperature, that is, a larger third set value.

For the metal sheets of different cross-sectional areas, the values of the pressure are also different, that is, the fourth set values are different.

Optionally, a larger cross-sectional area of the metal sheet indicates a larger fourth set value. In some embodiments, the fourth set value may be determined according to a formula (1):

F=aS formula (1)

Optionally, a larger thickness of the welding layer indicates a longer second set time. In some embodiments, the second set time may be determined according to a formula (3-1):

t′=md formula (3-1), where

in the formula (3-1), t′ is the second set time, m is a set weighting coefficient, and d is the thickness of the welding layer.

In some embodiments, the second set time may be determined according to a formula (3-2):

t′=md² formula (3-2), where

in the formula (3-2), t′ is the second set time, m is a set weighting coefficient, and d is the thickness of the welding layer.

In some embodiments, the second set time may be determined according to a formula (3-3):

t′=md³ formula (3-3), where

in the formula (3-3), t′ is the second set time, m is a set weighting coefficient, and d is the thickness of the welding layer.

In some embodiments, a value of the weighting coefficient m depends on a diffusion constant, an activation energy of diffusion, and a metallographic state after atomic diffusion.

The fourth set value is determined based on the formula (1), and the second set time is determined based on the formula (3-1), the formula (3-2), or the formula (3-2), so that the metal sheets can be securely bonded with each other, and the overall shapes and sizes of the parts meet design requirements, thereby ensuring bonding efficiency and precision.

In some examples, if relatively thick oxide layers and purities exist on surfaces of metal sheets, and a distance after each metal sheet is laminated does not meet a requirement of diffusion welding or friction welding, a higher temperature, a larger pressure, and a longer time may be are required during diffusion welding or friction welding. However, after bonding of diffusion welding or friction welding is performed based on such parameters, an overall shape and size of a part may have relatively large offsets from design standards. In this case, a molding step further needs to be added, so as to meet design requirements of the overall shape and size of the part, and as a result, bonding efficiency and precision are reduced.

As can be seen, in the method for additive manufacturing of a complex metal part by sheet lamination provided in this embodiment of the present invention, after layers are formed, fine grinding and cleaning are performed on the layers. Each metal sheet is then bonded into a part by using diffusion welding or friction welding. A step of fine grinding and cleaning may remove oxide layers and purities on surfaces of the metal sheets, so as to keep parameters in diffusion welding or friction welding at relatively desirable levels, thereby ensuring bonding efficiency and precision.

As an optional implementation manner, after Step 202 and before Step 203 in the embodiment shown in FIG. 2, a step of processing each metal sheet by using an electric spark may be further added. According to a shape characteristic of a part, an electric spark electrode having a corresponding shape is used to perform precision processing on one or more molded metal sheets, for example, perform precision processing on chamfers that have special shapes and on irregular structures and surfaces, so that precision and finish quality of the part can be therefore further improved.

As an optional implementation manner, in the embodiments shown in FIG. 1 and FIG. 2, a step of calculate a form-and-position tolerance and a size tolerance may be further included after diffusion welding or friction welding. Measurement data of a form, a position, and a size of a part that is formed through bonding using diffusion welding or friction welding are obtained. The obtained data is then compared with standard data, so that a form-and-position tolerance and a size tolerance may be calculated. A calculation result here may be used as a reference for adjusting a method procedure in the embodiment of the present invention, for example, adjusting layers of the three-dimensional data model, parameters of molding, or the like. Therefore, calculation of a form-and-position tolerance and a size tolerance helps to further improve precision and finish quality of the part.

In the foregoing embodiments of various possible combinations, diffusion welding with a different heating manner may be selected.

In the foregoing embodiments of various possible combinations, metal sheets that are made of a same material or different materials can be bonded through diffusion welding or friction welding into a part that meets requirements of precision and finish quality. For example, metal sheets of different alloy materials are bonded into a part. Especially, for a part having a complex structure, compared with a conventional additive manufacturing method, a more desirable effect can be achieved.

A system for implementing the foregoing method is provided below, and same principles and effects in the system are no longer elaborated hereinafter.

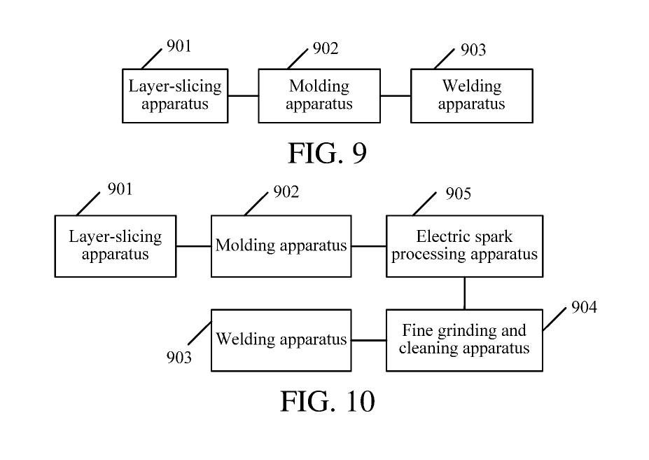

FIG. 9 is a block diagram of a system for additive manufacturing of a complex metal part by sheet lamination according to an exemplary embodiment. The system includes: a layer-slicing apparatus 901, a molding apparatus 902, and a welding apparatus 903.

The layer-slicing apparatus 901 is configured to slice a three-dimensional data model of a part into layers.

The molding apparatus 902 is configured to mold each layer to form a metal sheet.

The welding apparatus 903 is configured to combine each metal sheet into the part by using diffusion welding or friction welding.

As can be seen, in the system for additive manufacturing of a complex metal part by sheet lamination provided in this embodiment of the present invention, a three-dimensional data model of a part is first sliced into layers, each layer is then molded to form a metal sheet, and each metal sheet is eventually combined into the part by using diffusion welding or friction welding. In an aspect, a three-dimensional model of a part is sliced into layers, and each layer is molded to form a metal sheet. In this process, manufacturing may be completed layer by layer according to sizes and precision in a manufacturing process, so that precision and finish quality of each metal sheet can be ensured. In another aspect, diffusion welding and friction welding are both bonding techniques on an atomic level, so that bonding of metal sheets that meet requirements of precision and finish quality can be ensured. Based on the foregoing two aspects, requirements of precision and finish quality of an entire part can be met.

FIG. 10 is a block diagram of a system for additive manufacturing of a complex metal part by sheet lamination according to an exemplary embodiment. The system includes: a layer-slicing apparatus 901, a molding apparatus 902, a welding apparatus 903, a fine grinding and cleaning apparatus 904, and an electric spark apparatus 905.

The layer-slicing apparatus 901 is configured to slice a three-dimensional data model of a part into layers.

As an optional implementation manner, the layer-slicing apparatus 901 may be a computing apparatus such as a personal computer (PC). The layer-slicing apparatus 901 performs modeling on the part by using installed software, and slices the three-dimensional data model after modeling into layers. A principle of layer-slicing may be preset in the software. For example, when the structure of the part is more complex, a quantity of layers is larger; when the material of the part is softer, the quantity of layers is smaller; and when the size of the part is smaller, the size of the layers is smaller.

The molding apparatus 902 is configured to mold each layer to form a metal sheet.

As an optional implementation manner, the molding apparatus 902 may use data of the layers, and manufactures metal sheets through mechanical processing. The mechanical processing includes: laser cutting, plasma cutting, and processing using a machining center.

The electric spark processing apparatus 905 is configured to: before the fine grinding and cleaning apparatus 904 performs an operation, process each metal sheet by using an electric spark.

As an optional implementation manner, the electric spark processing apparatus 905 may be an electric spark machine tool and has an electric spark electrode, and performs precision processing on one or more molded metal sheets, for example, perform precision processing on chamfers that have special shapes and on irregular structures and surfaces.

The fine grinding and cleaning apparatus 904 is configured to: before the welding apparatus 903 performs an operation, perform fine grinding and cleaning on each metal sheet.

As an optional implementation manner, the fine grinding and cleaning apparatus 904 may include a grinding machine and a cleaning machine. The grinding machine first performs fine grinding on the metal sheets, and the cleaning machine then cleans the metal sheets after fine grinding, so as to remove oxide layers and purities on surfaces of the metal sheets.

The welding apparatus 903 is configured to combine each metal sheet into the part by using diffusion welding or friction welding.

In the embodiment shown in FIG. 9 or FIG. 10, the system for additive manufacturing of a complex metal part by sheet lamination may further include an AGV, which is a link that joins various apparatuses that are responsible for a manufacturing process in the system. The AGV conveys an article by means of landmark navigation, to achieve fully-automated operation of the system, so that the system becomes a flexible manufacturing system. A computer delivers an operation command to the AGV by using a control center, so as to accomplish conveyance between connected apparatuses. Therefore, an operator may deliver the operation command to the AGV by using the computer, so as to accomplish automated operation of whole system.

In the embodiment shown in FIG. 9, the AGV may convey, to the welding apparatus 903, each metal sheet that is formed by using the molding apparatus 902.

In the embodiment shown in FIG. 10, the AGV may convey, to the electric spark processing apparatus 905, each metal sheet that is formed by using the molding apparatus 902, and may further convey, to the fine grinding and cleaning apparatus 904, each metal sheet after processing by the electric spark processing apparatus 905, and may further convey, to the welding apparatus 903, each metal sheet after fine grinding and cleaning by the fine grinding and cleaning apparatus 904.

In an embodiment of another possible combination, the system for additive manufacturing of a complex metal part by sheet lamination may include some of the apparatuses shown in FIG. 10, and the AGV is still configured to accomplish conveyance between the apparatuses.

In the embodiment shown in FIG. 9 or FIG. 10, the system for additive manufacturing of a complex metal part by sheet lamination may further include an apparatus for calculating a form-and-position tolerance and a size tolerance, and the apparatus may be implemented by using a PC.

It should be understood that the present invention is not limited to the procedures and structures that are described above and shown in the accompanying drawings, and various modifications and changes can be made without departing from the scope of the present invention. The scope of present invention is defined by only the appended claims.

What is claimed is:

1. A method for additive manufacturing of a complex metal part by sheet lamination, the method comprises:
slicing a three-dimensional data model of a part into layers;
molding each layer to form a metal sheet; and
combining each metal sheet into the part by using diffusion welding or friction welding.

2. The method according to claim 1, the method further comprises:
before the combining each metal sheet into the part by using diffusion welding or friction welding, performing fine grinding and cleaning on each metal sheet.

3. The method according to claim 2, the method further comprises:
before the performing fine grinding and cleaning on each metal sheet, processing each metal sheet by using an electric spark.

4. The method according to claim 2, the performing fine grinding and cleaning on each metal sheet comprises:
performing fine grinding on each metal sheet according to a set parameter; and
cleaning each metal sheet after fine grinding, wherein
the set parameter comprises: a thickness of performing fine grinding on a surface of each metal sheet.

5. The method according to claim 4, the combining each metal sheet into the part by using diffusion welding comprises:
laminating each metal sheet after fine grinding and cleaning;
increasing a temperature to a first set value, and increasing a pressure to a second set value; and
when the first set value and the second set value are kept for over a first set time, reducing the temperature, and reducing the pressure, wherein
the first set value, the second set value, and the first set time are related to the thickness of performing fine grinding on a surface of each metal sheet.

6. The method according to claim 4, the combining each metal sheet into the part by using friction welding comprises:
laminating each metal sheet after fine grinding and cleaning;
increasing a temperature of each metal sheet to a third set value by producing friction between each metal sheet through driving;
stopping the friction, and increasing a pressure to a fourth set value; and
keeping the fourth set value over a second set time, wherein
the third set value, the fourth set value, and the second set time are related to the thickness of performing fine grinding on a surface of each metal sheet.

7. The method according to claim 1, the molding each layer to form a metal sheet comprises:
manufacturing each metal sheet through mechanical processing by using data of the layers, wherein the mechanical processing comprises laser cutting, plasma cutting, and processing using a machining center.

8. The method according to claim 1, the method further comprises:
obtaining measurement data of a form, a position, and a size of the part; and
comparing the measurement data with standard data, and calculating a form-and-position tolerance and a size tolerance.

9. The method according to claim 1, each metal sheet is made of a same material or different materials.

10. A system for additive manufacturing of a complex metal part by sheet lamination, the system comprises:
a layer-slicing apparatus, configured to slice a three-dimensional data model of a part into layers;
a molding apparatus, configured to mold each layer to form a metal sheet; and
a welding apparatus, configured to combine each metal sheet into the part by using diffusion welding or friction welding.

11. The system according to claim 10, the system further comprises:
a fine grinding and cleaning apparatus, configured to: before the welding apparatus performs an operation, perform fine grinding and cleaning on each metal sheet.

12. The system according to claim 11, the system further comprises:
an electric spark processing apparatus, configured to: before the fine grinding and cleaning apparatus performs an operation, process each metal sheet by using an electric spark.

13. The system according to claim 12, the system further comprises:
an automated guided vehicle (AGV), configured to convey each metal sheet after processing by the electric spark processing apparatus.

14. The system according to claim 11, the system further comprises:
an automated guided vehicle (AGV), configured to convey each metal sheet after the fine grinding and cleaning apparatus performs fine grinding and cleaning.

15. The system according to claim 10, the system further comprises:
an automated guided vehicle (AGV), configured to convey each metal sheet formed by using the molding apparatus.
